(19) United States
(12) Patent Application Publication
(10) Pub. No.: US 2007/0294188 A1
(43) Pub. Date: Dec. 20, 2007

(54) METHODS AND PROGRAMS OF DISPUTE RESOLUTION

(76) Inventor: Peter Merrill, Santa Fe, NM (US)

Correspondence Address: V. Gerald Grafe, esq., P.O. Box 2689, Corrales, NM, 87048, US

(21) Appl. No.: 11/563,917

(22) Filed: Nov. 28, 2006

Related U.S. Application Data
(60) Provisional application No. 60/814,342, filed on Jun. 16, 2006.

(51) Int. Cl. G06Q 10/00; H04L 9/00

(52) U.S. Cl. 705/80; 705/1

(57) ABSTRACT

The present invention includes methods and programs for dispute resolution that provide a dispute resolution process for use by two or more parties to any project. The methods and programs described herein include the formation of an expanded dispute review board, a mediation panes, and an arbitration panel. Each of the expanded DRB, the mediation panel and the arbitration panel share one or more members, and each party to a dispute resolution agreement described herein is bound to that agreement and to the results received from the DRB, the mediation panel., or the arbitration panel. The present invention also includes a comprehensive DRB that includes any and all parties to a large project in addition to the project owner or general contractor. The present invention also includes a settlement panel of trained and experienced individuals who are available, upon request, to provide advisory opinions, mediation and/or arbitration services.

### RELATED APPLICATIONS

The present application claims priority to provisional application Ser. No. 60/814,342, entitled “Methods Related to Producing Resolutions of Disputes,” and filed on Jun. 16, 2006, which is incorporated herein by reference in its entirety.

### BACKGROUND OF THE PRESENT INVENTION

1. Field of the Invention

The present invention relates generally to the field of construction and in particular the present invention relates to methods and programs of dispute resolution between two or more parties to a construction project.

2. History of the Related Art

Large commercial endeavors often require the participation and input of numerous parties, each of which as its own economic and working interests at heart. Unfortunately, in the course of any large project, disputes are almost certain to arise between two or more parties to the project for various reasons. In the United States, the dispute resolution process can be extremely expensive and time consuming. Prior to the introduction of alternative dispute resolution (ADR) systems such as mediation and arbitration, most disputes were settled in court. However, the average time for parties to complete litigation proceedings is now on the order of years rather than months, and thus litigation is always viewed as a last resort in dispute resolution.

Although recent years have seen an increase in the use of ADR techniques, the selection of mediators and/or arbitrators can also be a contentious and time consuming process. To the extent that any mediator or arbitrator provides a resolution to the dispute, there are still a number of parties that would rather have their day in court anyhow, which only leads to further costs and stresses on the project. The advent of the dispute review board (DRB) provided a measure of efficiency to the dispute resolution process, but all too often the authority of a typical DRB is minimized and the parties end up using other more costly processes in their dispute resolution processes.

The construction industry in particular has experienced no shortfall of delays, increased costs, and unfinished projects as a result of insufficient dispute resolution processes. Examples of construction delays, budget overreaching, and contentious working conditions abound in the United States. The completion of the “Big Dig” in Boston is one such example where the projected time and costs budgeted for the project were grossly overmatched by the actual time and cost it required to complete the project, because the Big Dig employed forty nine DRBs with advisory authority only. As disputes arise in the construction industry, any delays associated therewith cause an increase in the costs of the project. For example, the parties to the dispute often pay a significant amount of money for dispute resolution, whether through the ADR process or through litigation, which are outside of the authority of a typical DRB. Moreover, if the delay in the project is sufficiently long, there can be an increase in the cost of materials or the costs of services due to changing economic conditions, supply shortages, or changes in the service sector economy. To the extent that any construction project relies on government financing, whether through subsidy or debt financing, changes in the tax base, interest rates, or government leadership can cause irreparable harm to a project.

Therefore, there is a need in the art for methods and programs for dispute resolution that are comprehensive and all-inclusive in nature and permit the swift resolution of disputes with minimal impact on the timing and/or costs of the project.

### SUMMARY OF THE PRESENT INVENTION

Accordingly, the present invention includes methods and programs for dispute resolution that ensure a streamlined dispute resolution process with minimal impact on the overall health of a project. A first method of the present invention is a method of preventing and solving construction related disputes between a first party and a second party. This method includes the steps of providing a first panel including an expanded dispute review board (DRB) wherein the expanded DRB includes a neutral individual. Other steps are providing a second panel comprising a mediation panel, and providing a third panel comprising an arbitration panel, wherein the arbitration panel includes the neutral individual. Another step of the method recites providing the first panel, the second panel and the third panel in response to a mutual agreement between the first party and the second party.

A second method of the present invention is a method of resolving construction related disputes between a first party and a second party. This method includes the steps of providing the first party with a dispute resolution agreement to be executed by the first party, and providing the second party with the dispute resolution agreement to be executed by the second party. In this method the dispute resolution agreement includes a specification of a dispute resolution process that includes the formation of an expanded DRB to render an advisory opinion resolving a dispute, and the formation of an alternative dispute resolution (ADR) panel to resolve the dispute in response to the advisory opinion.

The present invention further includes a third method of resolving construction related disputes between a first party and a second party. The third method recites the steps of forming an expanded DRB including a neutral member, first party neutral, and a second party neutral. The method further includes the steps of submitting a dispute related to the project to the expanded DRB for resolution in the form of an advisory opinion, and submitting the dispute to an ADR panel in response to a request by one of the first party or the second party.

Variations and alternatives of selected example embodiments of the invention are described below with reference to the following figures.

### BRIEF DESCRIPTION OF THE DRAWINGS

FIG. 1 is a flowchart depicting a method of preventing and resolving construction related disputes in accordance with one example embodiment of the present invention.

FIG. 2 is a flowchart depicting a method of resolving construction related disputes in accordance with another example embodiment of the present invention.

FIG. 3 is a flowchart depicting a method of resolving construction related disputes in accordance with another example embodiment of the present invention.

FIG. 4 is a schematic block diagram of an expanded dispute resolution program operable in conjunction with one or more methods of the present invention.

FIG. 5 is a schematic block diagram of a comprehensive dispute resolution program operable in conjunction with one or more methods of the present invention.

FIG. 6 is a schematic block diagram of a comprehensive dispute resolution program operable in conjunction with one or more methods of the present invention.

FIG. 7 is a timeline depicting an example dispute resolution process in accordance with one or more methods of the present invention.

### DETAILED DESCRIPTION OF EXAMPLE EMBODIMENTS

A portion of the disclosure of this patent document contains material that is subject to copyright protection. The copyright owner has no objection to the facsimile reproduction by any one of the patent document or the patent disclosure, as it appears in the United States Patent and Trademark Office patent file or records, but otherwise reserves all copyright rights whatsoever. By way of example, the copyright owner does not object to the reproduction of the patent disclosure for the purposes of greater understanding of the present invention, but does not grant permission to use the copyrighted documents for any other purpose (e.g., reproducing them for use as agreements between parties is prohibited). Much of the description herein refers to disputes in the construction industry; however the present invention is also applicable to disputes in a wide variety of areas such as for example labor relationships, union matters, insurance, automobile sales and service, professional services, and family matters.

Details of the present invention are presented below in various example embodiments that will enable one skilled in the art to use the present invention. Reference is made to the figures described above, although it should be understood that the following description and the figures are merely exemplary in nature and that the scope of the present invention is defined exclusively in the appended claims.

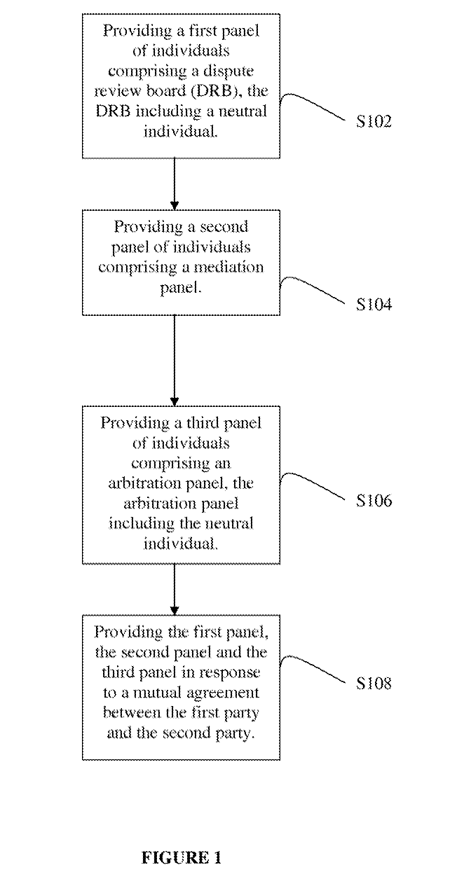

The present invention includes a method of preventing and solving construction related disputes between a first party and a second party. The flowchart of FIG. 1 depicts one example embodiment of the method of the present invention. The example method includes step S102, which recites providing a first panel including an expanded dispute review board (expanded DRB), the expanded DRB including a neutral individual. Step S104 of the example method recites providing a second panel comprising a mediation panel, and step S106 recites providing a third panel comprising an arbitration panel, the arbitration panel including the neutral individual. Step S108 of the example method recites providing the first panel, the second panel and the third panel in response to a mutual agreement between the first party and the second party.

A first variation of the example method includes the step of providing the first panes, the second panel and the third panel prior to the commencement of a project. The first, second and third panels can be provided as part of the bidding process of the project. That is, the owner of a project, which may be one of the first or second parties can stipulate to the providing the first, second and third panels as a condition of any bid to be accepted by a general contractor. The bidding process, contracting process, and subcontracting process can then all be subject to the example method of the present invention. Alternatively, the first party and the second party can agree to form a plurality of expanded DRBs, each with a different specialization or focus related to the project. Each of the plurality of expanded DRBs is configured to operate independently from the others, and to provide dispute resolution services to one or more aspects of the project.

In another variation of the example method, the expanded DRB includes the neutral individual, a first party neutral and a second party neutral. The expanded DRB functions as a dispute resolution body that is formed for the purpose of hearing any disputes that may arise between the first party and the second party. In formation, each of the first party and the second party select a first party neutral and a second party neutral, respectively. The first party and the second party then mutually select the neutral individual, who typically serves as the chairperson of the expanded DRB. Alternatively, the first party neutral and the second party neutral can select the neutral individual to serve as the chairperson of the expanded DRB. In this alternative, the selection process can include a provision that requires the first party and the second party to agree upon the selection of the neutral individual.

The first party neutral, second party neutral, and the neutral individual are selectable from a pool of trained and qualified DRB professionals, which can be provided by a DRB service provider such as the assignee of the present invention. Alternatively, the first and second party can opt to select the members of the expanded DRB from a general pool of construction industry experts that are not affiliated with any DRB service provider. The expanded DRB as provided herein functions to resolve disputes and further to provide advisory opinions, which can be binding or non-binding according to the terms of the agreement between the first party and the second party. Additionally, the expanded DRB or selected members of the expanded DRB can further serve as mediators and/or arbitrators of any dispute, and the mediation and/or arbitration proceedings can be binding or non-binding according to the agreement between the first party and the second party.

In another variation of the example method, the expanded DRB includes the neutral individual, a first party neutral a second party neutral, a first party representative and a second party representative. In this embodiment, the expanded DRB described above is extended to include representative members of the first and second party that participate in the DRB process, but generally will not have voting authority to engage in any subsequent mediation or arbitration proceedings due to their lack of mediation and/or arbitration training which is required of the first party neutral, the second party neutral, and the neutral individual. The first party representative and the second party representative are selectable by the respective parties, and are involved in the DRB process primarily to provide technical and substantive support to the neutral members of the expanded DRB.

In other variations of the example embodiment, the mediation and arbitration panels include selected members of the expanded DRB outlined above, in one variation of the example embodiment, the arbitration panel includes the neutral individual, the first party neutral and the second party neutral with the neutral individual serving as an arbitration panel chair. To the extent that either the first or second party has selected representatives as noted above, they are typically not included in the arbitration panel as they are not neutrally disposed towards any dispute concerning the project. To the extent that either of the first party neutral or second party neutral is privy to confidential information of another party that may cause a conflict of interest both the first party neutral and the second party neutral can be dismissed from the arbitration panel. In this case, the neutral individual will serve as the sole arbitrator of the dispute.

Similarly, the mediation panel is selected by the neutral individual, and can include for example one or both of the first party neutral or the second party neutral. Absent express consent by the first and second parties, the neutral individual typically will not serve on any mediation panel. To the extent that one or both of the first party neutral or the second party neutral are unavailable to serve on the mediation panel, the neutral individual is authorized to appoint a replacement mediator selected from national or international panels of construction ADR specialists. Alternatively, to the extent that one or both of the first party neutral or the second party neutral are unavailable to serve on the mediation panel, the remaining party neutral can be authorized to serve as a sole mediator of the dispute.

The example method of the present invention is configured to handle dispute resolution in a comprehensive manner, including any and all parties to a construction-related project. To that end, the first party and the second party described above can be any two distinct parties that are part of a construction project, including for example, a project owner, a general contractor, a subcontractor, a sub-subcontractor, a service provider, a material supplier or any combination thereof As noted above, a large project may necessitate the formation of multiple DRB's. Alternatively, a large project can handle its dispute resolutions through a single comprehensive DRB to which all parties, including any combination of those noted above, are subject to the example method described herein. Any one or any combination of the foregoing parties can be added to or removed from the comprehensive DRB process for any reason and at any time, including prior to commencement of the project, upon commencement of the project, or subsequent to commencement of the project.

In formation and operation, the expanded DRB can function as a continuous entity or as an ad hoc dispute resolution panel. In one variation of the example embodiment, the method further includes the step of scheduling the expanded DRB to meet at predetermined intervals during a predetermined period corresponding to a project. In this variation, the expanded DRB is an all-inclusive resource for all potential disputes that can arise during the course of a project, including time periods both before and after the project as the parties may agree. Alternatively, the method of the example embodiment can include the step of scheduling the expanded DRB to meet at a time selected by one of the first party or the second party. In this variation, the DRB functions more as a dispute resolution panel which is operative solely during actual disputes. Typically, the first and second parties will select the comprehensive DRB for larger projects involving a larger number of parties. Alternatively, the first and second parties can agree to a DRB process described above that is only implemented in the event of a dispute if and when a dispute should arise.

In another variation of the example method, the first and second parties can decide to form multiple extended DRBs or DRBs without any ADR authority outside the authority to render advisory opinions. Along with these multiple DRBs that are formed only to provide specialized construction expertise, additional special DRBs can be formed that are adapted to provide only mediation and/or arbitration services. The mediation and/or arbitration performed by a special DRB can be binding or nonbinding, as agreed upon by the first and second parties.

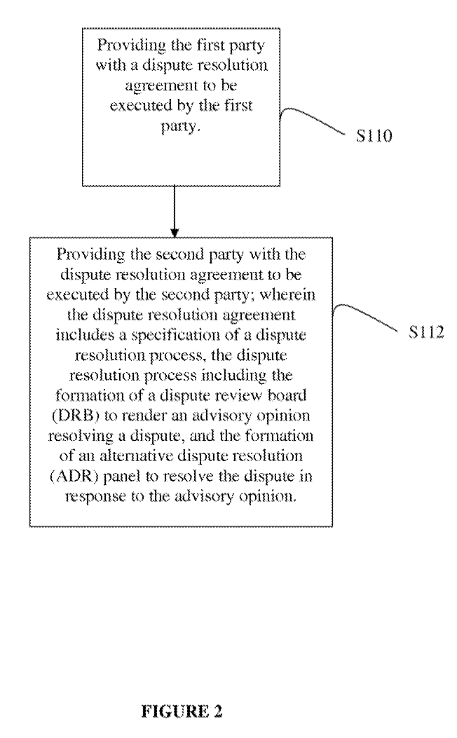

The present invention further includes a method of resolving construction related disputes between a first party and a second party. As shown in FIG. 2, this example method includes step S110, which recites providing the first party with a dispute resolution agreement to be executed by the first party. The example method further recites the step of providing the second party with the dispute resolution agreement to be executed by the second party, as shown in step S112. According to the example method the dispute resolution agreement includes a specification of a dispute resolution process that includes the formation of an expanded DRB to render an advisory opinion resolving a dispute, and the formation of an ADR panel to resolve the dispute in response to the advisory opinion.

Execution of the dispute resolution agreement allows the first party and the second party to expeditiously enter into the dispute resolution process without any of the hassles or delays typically associated with the ADR process. For example, in a typical ADR process the parties first must agree to an ADR resolution to their dispute, then agree on the type of ADR to be employed, then agree upon one or more mediators and/or arbitrators, and then finally execute any mediation and/or arbitration agreements. Thus the typical ADR process is quite cumbersome for parties and can result in significant delays to a project. The example method described above provides for the simultaneous formation of the expanded DRB with the ADR panel, thus accelerating the ADR process if it is needed in response to the advisory opinion provided by the DRB. As noted above, the example method provides both the expanded DRB and the ADR panel, and the respective panels are immediately responsive to any dispute that may arise between the first party and the second party. Moreover, as noted below with respect to variations of the present invention, the benefits of the example method are equally applicable to a comprehensive DRB, in which all or substantially all parties to a construction project are committed to the DRB and ADR process described in the example method.

As described above with reference to FIG. 1. In one variation of the example method, the expanded DRB and the ADR panel can be composed of substantially the same individuals. In particular, in one variation of the example embodiment, the expanded DRB can include a neutral individual, a first party neutral and a second party neutral. As noted above, each of the first party and the second party select a first party neutral and a second party neutral, respectively. The first party and the second party then mutually select the neutral individual, who typically serves as the chairperson of the expanded DRB. Alternatively, the first party neutral and the second party neutral can recommend to the first and second party the neutral individual to serve as the chairperson of the expanded DRB. In this alternative, the selection process can include a provision that requires the first party and the second party to agree upon the selection of the neutral individual.

The first party neutral, second party neutral, and the neutral individual are selectable from a pool of trained and qualified DRB professionals, which can be provided by a DRB service provider such as the assignee of the present invention. Alternatively, the first and second party can opt to select the members of the DRB from a general pool of construction industry experts that are not affiliated with any DRB service provider. The expanded DRB as provided herein functions to resolve disputes and further to provide advisory opinions, which are non-binding according to the terms of the agreement between the first party and the second party. Additionally, the expanded DRB or selected members of the expanded DRB can further serve as mediators and/or arbitrators of any dispute, and the mediation and/or arbitration proceedings can be binding or non-binding according to the agreement between the first party and the second party.

In another variation of the example embodiment, the expanded DRB includes the neutral individual, a first party neutral, a second party neutral, a first party representative and a second party representative. As in the foregoing embodiment the expanded DRB of the example method is expanded to include representative members of the first and second party that participate in the DRB process, but generally will not have voting authority to engage in any subsequent mediation or arbitration proceedings. The first party representative and the second party representative are selectable by the respective parties, and are involved in the DRB process primarily to provide technical and substantive support to the neutral members of the expanded DRB.

In another variation of the example embodiment, the ADR panel includes the first party neutral and the second party neutral. Alternatively, the ADR panel can include the neutral individual alone or in combination with the first party neutral and the second party neutral. The ADR panel is configured to adapt as one or both of a mediation panel or an arbitration panel, wherein both the mediation and arbitration panels include at least partially the same individuals. Both the mediation and arbitration processes can be binding or non-binding, as agreed upon by the first party and the second party.

In one variation of the example embodiment in which the ADR panel acts as an arbitration panel, the arbitration panel includes the neutral individual, the first party neutral and the second party neutral, with the neutral individual serving as an arbitration panel chair. To the extent that either the first or second party has selected representatives as noted above, they are typically not included in the arbitration panel as they are not neutrally disposed towards any dispute concerning the project. To the extent that either of the first party neutral or second party neutral is privy to confidential information of another party that may cause a conflict of interest, both the first party neutral and the second party neutral can be dismissed from the arbitration panel. In this case, the neutral individual will serve as the sole arbitrator of the dispute.

If the ADR panel is acting as a mediation panel, then the mediation panel is selected by the neutral individual, and can include for example one or both of the first party neutral or the second party neutral. Absent express consent by the first and second parties, the neutral individual typically will not serve on any mediation panel, in order to keep his or her neutrality if the dispute should proceed to arbitration. To the extent that one or both of the first party neutral or the second party neutral are unavailable to serve on the mediation panel, the neutral individual is authorized to appoint a replacement mediator selected from national or international panels of construction ADR specialists. Alternatively, to the extent that one or both of the first party neutral or the second party neutral are unavailable to serve on the mediation panel, the remaining party neutral can be authorized to serve as a sole mediator of the dispute, although this is not typically done should the dispute proceed to arbitration.

The timing of steps S110 and S112 is another variation of the example method described above. In various alternatives, the dispute resolution agreement is provided to the first party and the second party prior to commencement of a project, upon the commencement of a project, or subsequent to the commencement of a project. The timing of the creation of the expanded DRB is a function of the time at which the first party and the second party execute the agreement, with regard to any additional timing provisions that can be included in the agreement. As noted above, the expanded DRB can be configured to act on a regular and all-inclusive basis, or on an ad hoc basis in accordance with the wishes of the first party and the second party thereby operating as a so-called settlement panel. To the extent that the parties intend to create the expanded DRB in conjunction with the bidding process, then the dispute resolution agreement is provided to the first party and the second party prior to commencement of the project. Alternatively, the addition of one or more parties to the project upon the commencement of the project may be subject to the additional parties' execution of the dispute resolution agreement. Finally, if any party needs to be replaced for any reason during the project, then the replacement party may be added into the DRB process by receiving the dispute resolution agreement subsequent to the commencement of the project.

The example method shown in FIG. 2 is configured to handle dispute resolution in a comprehensive manner, including any and all parties to a construction-related project. To that end, the first party and the second party described above can be any two distinct parties that are part of a construction project, including for example, a project owner, a general contractor, a subcontractor, a sub-subcontractor, a service provider, a material supplier or any combination thereof. As noted above, a large project may necessitate the formation of multiple expanded DRBs. Alternatively, a large project can handle its dispute resolutions through a single comprehensive DRB to which all parties, including any combination of those noted above, are subject to the example method described herein. As noted above, any one or any combination of the foregoing parties can be added to or removed from the expanded DRB process for any reason and at any time, including prior to commencement of the project upon commencement of the project, or subsequent to commencement of the project.

In another variation of the example method, the first and second parties can decide to form multiple extended DRBs or DRBs without any ADR authority outside the authority to render advisory opinions. Along with these multiple DRBs that are formed only to provide specialized construction expertise, additional special DRBs can be formed that are adapted to provide only mediation and/or arbitration services. The mediation and/or arbitration performed by a special DRB can be binding or non-binding, as agreed upon by the first and second parties.

In another variation of the example method, the expanded DRB can function as a continuous entity or as an ad hoc dispute resolution panel. In one variation of the example embodiment, the method further includes the step of scheduling the expanded DRB to meet at predetermined intervals during a predetermined period corresponding to a project. In this variation, the expanded DRB is an all-inclusive resource for all potential disputes that can arise during the course of a project, including time periods both before and after the project as the parties may agree. Alternatively, the method of the example embodiment can include the step of scheduling the expanded DRB to meet at a time selected by one of the first party or the second party. In this variation, the DRB functions more as a dispute resolution panel, also called a settlement panel, which is operative solely during actual disputes. Typically, the first and second parties will select the comprehensive DRB for larger projects involving a larger number of parties. On the other hand, the first and second parties can agree to a DRB process described above that is only implemented in the event of a dispute if and when a dispute should arise.

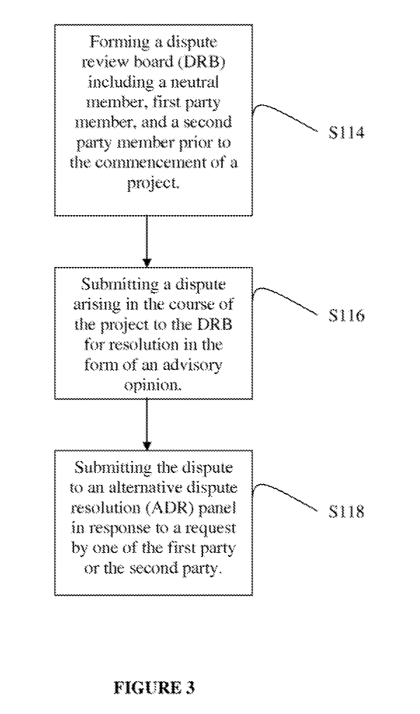

The present invention further includes a method of resolving construction related disputes between a first party and a second party. As shown in FIG. 3, an example embodiment of the method includes step S114, which recites forming an expanded DRB including a neutral member, first party neutral, and a second party neutral. Step S116 of the example embodiment recites submitting a dispute related to the project to the expanded DRB for resolution in the form of an advisory opinion, and step S118 recites submitting the dispute to an ADR panel in response to a request by one of the first party or the second party.

In one variation of the example method, the expanded DRB is extended to include a first party representative and a second party representative. As in the prior embodiments described above, the representative members of the first and second party participate in the DRB process including the issuance of advisory opinions. Generally, however, the first party representative and the second party representative wilt not have voting authority to engage in any subsequent mediation or arbitration proceedings. The first party representative and the second party representative are selectable by the respective parties, and are involved in the DRB process primarily to provide technical and substantive support to the neutral members of the expanded DRB.

In another variation of the example embodiment, the ADR panel includes the first party neutral and the second party neutral. Alternatively, the ADR panel can include the neutral individual alone or in combination with the first party neutral and the second party neutral. The ADR panel is configured to adapt as one or both of a mediation panel or an arbitration panel, wherein both the mediation and arbitration panels include at least partially the same individuals. Both the mediation and arbitration processes can be binding or non-binding, as agreed upon by the first party and the second party.

In one variation of the example embodiment in which the ADR panel acts as an arbitration panel, the arbitration panels includes the neutral individual, the first party neutral and the second party neutral, with the neutral individual serving as an arbitration panel chair. To the extent that either the first or second party has selected representatives as noted above, they are typically not included in the arbitration panel as they are not neutrally disposed towards any dispute concerning the project. To the extent that either of the first party neutral or second party neutral is privy to confidential information of another party that may cause a conflict of interest, both the first party neutral and the second party neutral can be dismissed from the arbitration panel. In this case, the neutral individual will serve as the sole arbitrator of the dispute.

If the ADR panel is acting as a mediation panel, then the mediation panel is selected by the neutral individual, and can include for example one or both of the first party neutral or the second party neutral. Absent express consent by the first and second parties, the neutral individual typically will not serve on any mediation panel. To the extent that one or both of the first party neutral or the second party neutral are unavailable to serve on the mediation panel, the neutral individual is authorized to appoint a replacement mediator selected from national or international panels of construction ADR specialists. Alternatively, to the extent that one or both of the first party neutral or the second party neutral are unavailable to serve on the mediation panel, the remaining party neutral can be authorized to serve as a sole mediator of the dispute.

As in the prior example embodiment, the method depicted in FIG. 3 includes variations as to the timing of the formation of the expanded DRB. In various alternatives, the dispute resolution agreement is provided to the first party and the second party prior to commencement of a project, upon the commencement of a project, or subsequent to the commencement of a project. The timing of the creation of the expanded DRB is a function of the time at which the first party and the second party execute the agreement, with regard to any additional timing provisions that can be included in the agreement. As noted above, the expanded DRB can be configured to act on a regular and all-inclusive basis, or on an ad hoc basis in accordance with the wishes of the first party and the second party. To the extent that the parties intend to create the expanded DRB in conjunction with the bidding process, then the dispute resolution agreement is provided to the first party and the second party prior to commencement of the project. Alternatively, the addition or subtraction of one or more parties to the project upon the commencement of the project may be subject to the additional or replacement parties' execution of the dispute resolution agreement subsequent to the commencement of the project.

As in the previous embodiments, the definitions of the first party and the second party are broad enough to cover any two parties that are participants in a construction project. The first party and the second party described above can be any two distinct parties that are part of a construction project, including for example, a project owner, a general contractor, a subcontractor, a sub-subcontractor, a service provider, a material supplier or any combination thereof. As noted above, a large project may necessitate the formation of multiple expanded DRBs. Alternatively, a large project can handle its dispute resolutions through a single comprehensive DRB to which all parties, including any combination of those noted above, are subject to the example method described herein. Due to the addition or subtraction of one or more parties to the project, any one or any combination of the foregoing parties can be added to or removed from the DRB process for any reason and at any time, including prior to commencement of the project, upon commencement of the project, or subsequent to commencement of the project.

In another variation of the example method, the expanded DRB can function as a continuous entity or as an ad hoc dispute resolution panel. In one variation of the example embodiment, the method further includes the step of scheduling the expanded DRB to meet at predetermined intervals during a predetermined period corresponding to a project. In this variation, the expanded DRB is an all-inclusive resource for all potential disputes that can arise during the course of a project, including time periods both before and after the project as the parties may agree. Alternatively, the method of the example embodiment can include the step of scheduling the DRB to meet at a time selected by one of the first party or the second party. In this variation the DRB functions more as a dispute resolution panel, also called a settlement panel, which is operative solely during actual disputes. Typically, the first and second parties will select the comprehensive DRB for larger projects involving a larger number of parties. Alternatively, the first and second parties can agree to a DRB process described above that is only implemented in the event of a dispute if and when a dispute should arise.

In another variation of the example method, the first and second parties can decide to form multiple extended DRBs or DRBs without any ADR authority outside the authority to render advisory opinions. Along with these multiple DRBs that are formed only to provide specialized construction expertise, additional special DRBs can be formed that are adapted to provide only mediation and/or arbitration services. The mediation and/or arbitration performed by a special DRB can be binding or non-binding, as agreed upon by the first and second parties.

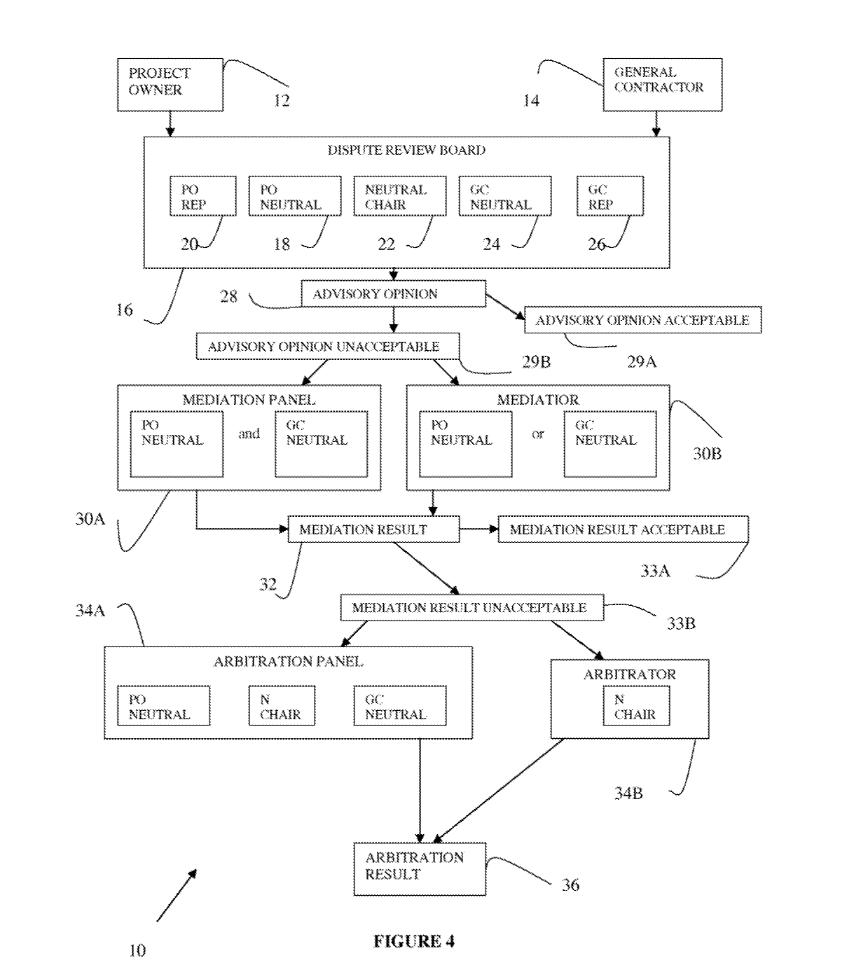

Other features and advantages of the present invention are demonstrated in FIG. 4, which is a schematic block diagram of an expanded dispute resolution program 10 that is usable in conjunction with the methods described above. The program 10 generally includes a project owner 12 and a general contractor 14 that agree to enter into the program through one or more of the methods described herein. For purposes of discussion, the project owner 12 and the general contractor 14 are selected as first and second parties in the program 10. However, as noted repeatedly herein, the program can include any two or more parties that are participants in a construction project, including for example the project owner 12, the general contractor 14, a subcontractor, a sub-subcontractor, a service providers a material supplier or any combination thereof.

Pursuant to the methods described herein, the project owner 12 and the general contractor 14 agree to the formation of an expanded DRB 16. As noted above, the expanded DRB 16 can include the neutral individual 22, a first party (project owner) neutral 18 and a second party (general contractor) neutral 24 The expanded DRB 16 functions as a dispute resolution body that is formed for the purpose of hearing any disputes that may arise between the project owner 12 and the general contractor 14. In formation, the project owner 12 selects the project owner neutral 18 and the general contractor 14 selects the general contractor neutral 24. The project owner 12 and the general contractor 14 then mutually select the neutral individual 22, who typically serves as the chairperson of the expanded DRB. Alternatively, the project owner neutral 18 and the general contractor neutral 24 can select the neutral individual 22 to serve as the chairperson of the expanded DRB. In this alternative, the selection process can include a provision that requires the project owner 12 and the general contractor 14 to agree upon the selection of the neutral individual 22.

In variations described above, the expanded DRB can be extended to include a project owner representative 20 and a general contractor representative 26. The representative members of the project owner 12 and the general contractor 14 participate in the program 10 including the issuance of advisory opinions 28. Generally, however, the project owner representative 20 and the general contractor representative 26 will not have voting authority to engage in any subsequent mediation or arbitration proceedings contained in the program 10. The project owner representative 20 and the general contractor representative 26 are selectable by the respective parties and are involved in the expanded DRB 16 process primarily to provide technical and substantive support to the neutral members of the expanded DRB 16 as noted above.

As noted above the expanded DRB 16 functions in part to provide an advisory opinion 28 that can aid in the resolution of any disputes between the project owner 12 and the general contractor 14. If the advisory opinion is acceptable 29A to both parties, then the dispute resolution process is completed with regards to the dispute at issue In the event that the advisory opinion is unacceptable 29B satisfactory to one or both of the parties, then the program 10 includes one or more ADR options, which can include mediation, arbitration, binding mediation, binding arbitration, mediation-arbitration or arbitration-mediation.

In the example program 10, ADR options include a mediation panel 30A 30B and an arbitration panel 34A. The mediation panel 30A includes the project owner neutral 18 and the general contractor neutral 26 that function to produce a mediation result 32. Alternatively, one of the project owner neutral 18 or the general contractor neutral 26 can serve as a sole mediator 30B to provide the mediation result 32. As describe above., the mediation panel 30A is typically selected by the neutral individual 22, and can include for example one or both of the project owner neutral 18 and the general contractor neutral 26. Absent express consent by the project owner 12 and the general contractor 14, the neutral individual 22 typically will not serve on the mediation panel 3SA. To the extent that one or both of the project owner neutral 18 and the general contractor neutral 26 are unavailable to serve on the mediation panel 30A, the neutral individual 22 is authorized to appoint a replacement mediator selected from national or international panels of construction ADR specialists. Alternatively, to the extent that one or both of the project owner neutral 18 and the general contractor neutral 26 are unavailable to serve on the mediation panel 30A, the remaining party neutral can be authorized to serve as a sole mediator of any dispute according to the program 10.

If the mediation result is acceptable 33A to both of the parties in the program 10, then the dispute resolution process is terminated with respect to the dispute at issue. If the mediation result is unacceptable 33A to one or both of the parties in the program 10, then they may proceed to arbitration by the arbitration panel 34A or a sole arbitrator 348. The arbitration panel 34A can include can include the neutral individual 22, the project owner neutral 18 and the general contractor neutral 24. The sole arbitrator 348 will typically be the neutral individual 22. The arbitration panel 34A functions to provide an arbitration result 36 regarding any disputes that may arise between the project owner 12 and the general contractor 14. As noted above, the arbitration result 36 can be either binding or non-binding, depending upon the program 10 selected by the project owner 12 and the general contractor 14.

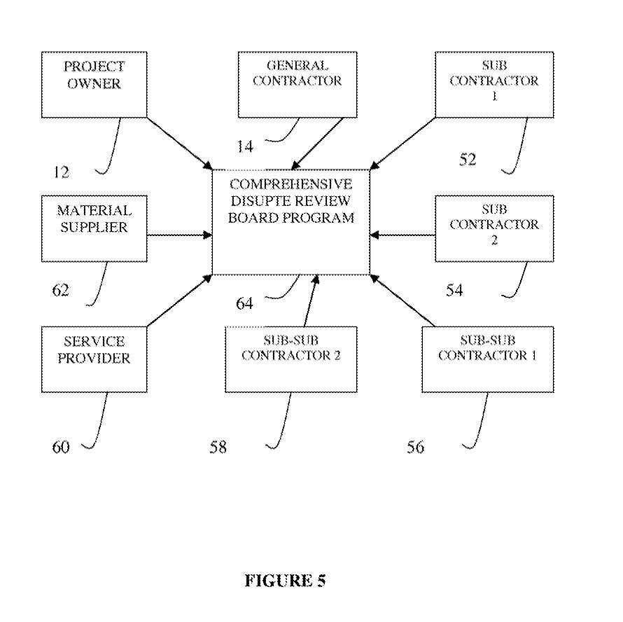

The methods of the present also enable the parties to form a comprehensive DRB 64, as shown in FIG. 5. A comprehensive DRB 64 includes a DRB of the type described above including more than two parties. As in the example embodiments described above, the parties to a comprehensive DRB 64 can include any and all parties that are involved, at any time, in a construction project. As shown in FIG. 5, an example comprehensive DRB includes a project owner 12, a general contractor 14, a first subcontractor 52, a second subcontractor 54, a first sub-subcontractor, a second subsubcontractor 58, a service provider 60, and a material supplier 62. At any time prior to the commencement of the project, upon commencement of the project, or subsequent to commencement of the project any of the foregoing example parties can become party to the comprehensive DRB.

As used herein, each of the terms denoting the parties should be construed in their broadest sense. A general contractor 14, for example, includes any contractor, developer or the like that is capable of performing certain tasks for the project owner 14, or alternatively is capable of contracting with a third party for the performance of those tasks. A subcontractor 52, 54 includes any third party that can enter into a contract with the general contractor 14 for the performance of those tasks, or alternatively is capable of contracting with a fourth party for the performance of those tasks. A sub-subcontractor 56, 58 includes any fourth party that can enter into a contract with a subcontractor 52, 54 for the performance of those tasks, or alternatively is capable of contracting with a fifth party (a sub-sub-subcontractor) for the performance of those tasks.

A service provider 60 includes any entity or natural person that contributes to the completion of a project through the performance of services that are otherwise not provided by the general contractor 14, any subcontractors 52, 54, or any sub-subcontractors 56, 58. Example service providers 60 include architects, developers, designers, surveyors, advisors, consultants, accountants, insurers, attorneys, clerical or bookkeeping services and the like. A material supplier 62 includes any entity or natural person that contributes to the completion of a project through the supply of materials that are otherwise not provided by the project owner 12, general contractor 14, any subcontractors 52, 54, or any sub-subcontractors 56, 58. Example material suppliers 62 include suppliers of raw materials such as steel, concrete, asphalt, glass or other building or roadway materials, as well as suppliers of vegetation, rock and other landscaping materials. Other material suppliers 62 include suppliers of fabricated materials such as telecommunications equipment, computers, wiring, networking hardware, computer software, electrical hardware, lighting hardware and the like.

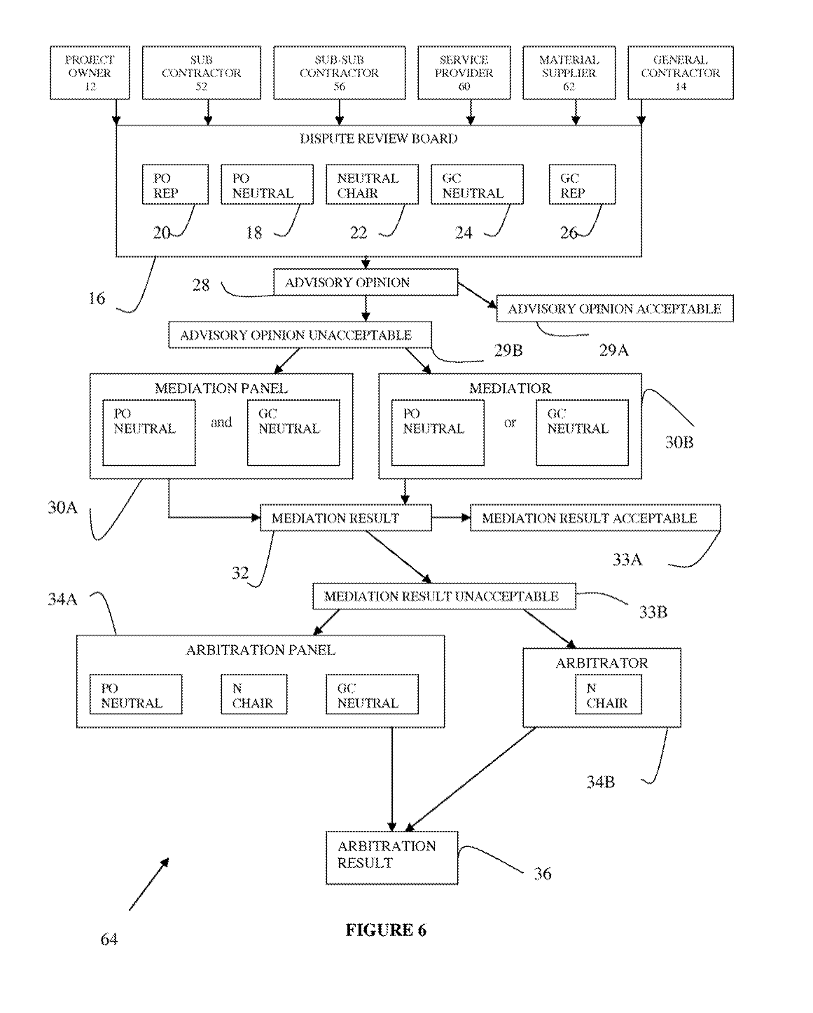

FIG. 6 is a schematic block diagram of a comprehensive dispute resolution program 64 that is usable in conjunction with the methods described above. The program 64 can include for example a project owner 12, a general contractor 14, a subcontractor 52, a sub-subcontractor 56, a service provider 60 and a material supplier 62 that agree to enter into the program through one or more of the methods described herein. For purposes of discussion, the project owner 12 and the general contractor 14 are selected as first and second parties in the program 64. However, as noted repeatedly herein, the program can include any two or more parties that are participants in a construction project, including for example the project owner 12, the general contractor 14, a subcontractor 52, a sub-subcontractor 56, a service provider 60, a material supplier 62 or any combination thereof.

Pursuant to the methods described herein, the project owner 12 and the general contractor 14 agree to the formation of an expanded DRB 16. As noted above, the expanded DRB 16 can include the neutral individual 22, a first party (project owner) neutral 18 and a second party (general contractor) neutral 24. The expanded DRB 16 functions as a dispute resolution body that is formed for the purpose of hearing any disputes that may arise between the project owner 12 and the general contractor 14. In formation, the project owner 12 selects the project owner neutral 18 and the general contractor 14 selects the general contractor neutral 24. The project owner 12 and the general contractor 14 then mutually select the neutral individual 22, who typically serves as the chairperson of the expanded DRB. Alternatively, the project owner neutral 18 and the general contractor neutral 24 can select the neutral individual 22 to serve as the chairperson of the expanded DRB. In this alternative, the selection process can include a provision that requires the project owner 12 and the general contractor 14 to agree upon the selection of the neutral individual 22.

In variations described above, the expanded DRB can be extended to include a project owner representative 20 and a general contractor representative 26. The representative members of the project owner 12 and the general contractor 14 participate in the program 64 including the issuance of advisory opinions 28. Generally, however, the project owner representative 20 and the general contractor representative 26 will not have voting authority to engage in any subsequent mediation or arbitration proceedings contained in the program 64. The project owner representative 20 and the general contractor representative 26 are selectable by the respective parties, and are involved in the expanded DRB process primarily to provide technical and substantive support to the neutral members of the expanded DRB 16 as noted above.

As noted above, the expanded DRB 16 functions in part to provide an advisory opinion 28 that can aid in the resolution of any disputes between the project owner 12 and the general contractor 14, if the advisory opinion is acceptable 29A to both parties, then the dispute resolution process is completed with regards to the dispute at issue. In the event that the advisory opinion is unacceptable 29B satisfactory to one or both of the parties, then the program 64 includes one or more ADR options, which can include mediation, arbitration, binding mediation, binding arbitration, mediation-arbitration, or arbitration-mediation.

In the example program 64, ADR options include a mediation panel 30A 30B and an arbitration panel 34A. The mediation panel 30A includes the project owner neutral 18 and the general contractor neutral 26 that function to produce a mediation result 32. Alternatively, one of the project owner neutral 18 or the general contractor neutral 26 can serve as a sole mediator 30B to provide the mediation result 32. As describe above, the mediation panel 30A is typically selected by the neutral individual 22, and can include for example one or both of the project owner neutral 18 and the general contractor neutral 26. Absent express consent by the project owner 12 and the general contractor 14, the neutral individual 22 typically will not serve on the mediation panel 30A. To the extent that one or both of the project owner neutral 18 and the general contractor neutral 26 are unavailable to serve on the mediation panel 30A, the neutral individual 22 is authorized to appoint a replacement mediator selected from national or international panels of construction ADR specialists. Alternatively, to the extent that one or both of the project owner neutral 18 and the general contractor neutral 26 are unavailable to serve on the mediation panel 30A, the remaining party neutral can be authorized to serve as a sole mediator of any dispute according to the program 64.

If the mediation result is acceptable 33A to both of the parties in the program 10, then the dispute resolution process is terminated with respect to the dispute at issue. If the mediation result is unacceptable 33A to one or both of the parties in the program 64, then they may proceed to arbitration by the arbitration panel 34A or a sole arbitrator 348. The arbitration panel 34A can include can include the neutral individual 22, the project owner neutral 18 and the general contractor neutral 24. The sole arbitrator 34B will typically be the neutral individual 22. The arbitration panel 34A functions to provide an arbitration result 36 regarding any disputes that may arise between the project owner 12 and the general contractor 14. As noted above, the arbitration result 36 can be either binding or non-binding, depending upon the program 64 selected by the project owner 12 and the general contractor 14.

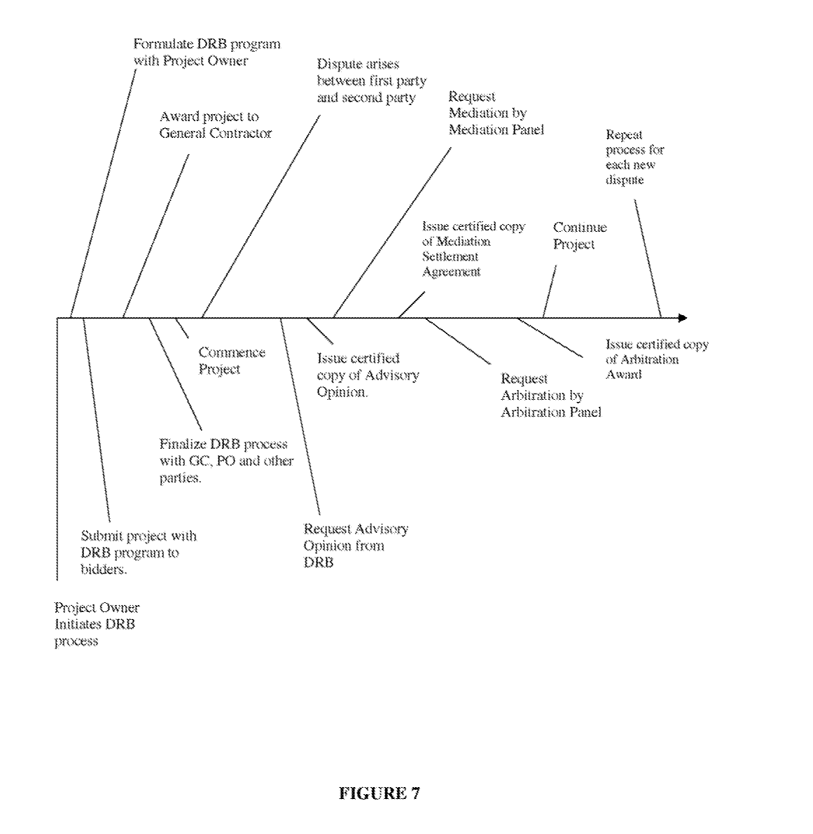

The dispute resolution methods described herein can follow a typical timeline, which is shown in FIG. 7. In the creation and implementation of the expanded or comprehensive DRB programs described herein, a project owner initiates the DRB process by approaching a DRB program administrator such as the assignee of the present invention. The project owner and the program administrator then formulate the expanded or comprehensive DRB program with particular attention to the details and requirements of the contemplated project. Once the expanded or comprehensive DRB program is finalized, the project owner submits the project to bidders subject to the expanded or comprehensive DRB program and methods described herein. Following award of the project to the general contractor, the expanded or comprehensive DRB process is then finalized with the general contractor and any other parties that may be subject to the expanded or comprehensive DRB program, such as for example those parties outlined above with reference to the comprehensive DRB program.

If a dispute arises following commencement of the project between a first party and a second party, then the first party, the second party, or both request an advisory opinion from the expanded or comprehensive DRB. As noted above, the first party and the second party can be any one of one of a project owner, a general contractor, a subcontractor, a sub-subcontractor, a material supplier or a service provider, as those terms are defined herein. The expanded or comprehensive DRB of the type described above then issues a certified copy of the advisory opinion to the first party and the second party. In most cases, the advisory opinion is sufficient for both parties, and the project can resume immediately.

In the event that the advisory opinion is unsatisfactory to the first party or the second party, then either of the parties can request a mediation of the dispute by a mediation panel formed according to the example methods described herein. The mediation can be binding or non-binding, depending upon the terms of the expanded or comprehensive DRB agreement. In most cases, the mediation will involve one or more of the first party neutral and the second party neutral, although alternate mediators can be used in other circumstances described above. The mediation panel or sole mediator will then issue a certified copy of the mediation settlement agreement to the first and second parties.

If the mediation proves unsatisfactory to one or both of the first party and the second party, then one or both of the parties can request an arbitration by an arbitration panel or sole arbitrator formed according to the example methods described herein. The arbitration can also be binding or non-binding, depending upon the terms of the expanded or comprehensive DRB agreement. As noted above, the arbitration panel can include the first party neutral, the second party neutral, and the chair of the expanded or comprehensive DRB who also serves as the chair of the arbitration panel. The arbitration panel or sole arbitrator will issue a certified copy of the arbitration award to the first and second parties. The terms of the expanded or comprehensive DRB can subject the parties to binding arbitration, in which case the result of the arbitration panel is final and the project is continued without any undue delay. In those circumstances in which the arbitration is non-binding, then any unsatisfactory arbitration award can lead one or more of the parties to take legal proceedings outside of the scope of the expanded or comprehensive DRB programs described herein in order to resolve the dispute.

The processes described herein are repeatable for any number of parties and for any number of disputes arising in the course of a construction project, and each of the expanded and comprehensive DRB programs is fully customizable to provide the most efficient resolution of disputes in accordance with the methods and programs described herein. The present invention has been described with reference to several example embodiments that will enable one skilled in the art to use the present invention. It should be understood that the foregoing description and the figures are merely exemplary in nature and that various trivial and obvious modifications to those embodiments could be readily devised by those skilled in the art without departing from the scope of the present invention which is defined by the following claims.

I claim:

1. A method of preventing and solving construction related disputes between a first party and a second party, the method comprising:
providing a first panel comprising a dispute review board (DRB) the DRB including a neutral individual;
providing a second panel comprising a mediation panel;
providing a third panel comprising an arbitration panel the arbitration panel including the neutral individual; and
providing the first panel the second panel and the third panel in response to a mutual agreement between the first party and the second party.

2. The method of claim 1 further comprising the step of providing the first panel, the second panel and the third panel prior to the commencement of a project.

3. The method of claim 1 wherein the DRB includes the neutral individual, a first party neutral and a second party neutral.

4. The method of claim 1 wherein the DRB includes the neutral individual, a first party neutral, a second party neutral, a first party representative and a second party representative.

5. The method of claim 1 wherein the arbitration panel includes the neutral individual, the first party neutral and the second party neutral.

6. The method of claim 1 wherein the mediation panel includes one of the first party neutral or the second party neutral.

7. The method of claim 1 wherein the first party includes a project owner.

8. The method of claim 1 wherein the second party includes a general contractor.

9. The method of claim 1 wherein the second party includes a subcontractor of the general contractor.

10. The method of claim 1 wherein the second party includes a sub-subcontractor of a subcontractor.

11. The method of claim 1 wherein the first party comprises one of a project owner, a general contractor, a subcontractor, a sub-subcontractor, a material supplier or a service provider.

12. The method of claim 1 wherein the second party comprises one of a project owner, a general contractor, a subcontractor, a sub-subcontractor, a material supplier or a service provider.

13. The method of claim 1 further comprising the step of scheduling the DRB to meet at predetermined intervals during a predetermined period corresponding to a project.

14. The method of claim 1 further comprising the step of scheduling the DRB to meet at a time selected by one of the first party or the second party.

15. The method of claim 1 wherein the DRB is adapted to provide an advisory opinion relating to a solution of the construction related dispute.

16. A method of resolving construction related disputes between a first party and a second party, the method comprising:
providing the first party with a dispute resolution agreement to be executed by the first party; and
providing the second party with the dispute resolution agreement to be executed by the second party;
wherein the dispute resolution agreement includes a specification of a dispute resolution process, the dispute resolution process including the formation of a dispute review board (DRB) to render an advisory opinion resolving a dispute, and the formation of an alternative dispute resolution (ADR) panel to resolve the dispute in response to the advisory opinion.

17. The method of claim 16 wherein the DRB and the ADR panel are comprised of substantially the same individuals.

18. The method of claim 16 wherein the DRB includes a neutral individual, a first party neutral and a second party neutral.

19. The method of claim 16 wherein the DRB includes the neutral individual, a first party neutral, a second party neutral, a first party representative and a second party representative.

20. The method of claim 16 wherein the ADR panel includes the first party representative and the second party representative.

21. The method of claim 20 wherein the ADR panel includes the neutral individual.

22. The method of claim 16 wherein the ADR panel includes a mediation panel.

23. The method of claim 22 wherein the ADR panel includes an arbitration panel, and wherein the mediation panel and the arbitration panel are at least partially comprised of substantially the same individuals.

24. The method of claim 16 wherein the dispute resolution agreement is provided to the first party and the second party prior to commencement of a project.

25. The method of claim 16 wherein the dispute resolution agreement is provided to the first party and the second party upon the commencement of a project.

26. The method of claim 16 wherein the dispute resolution agreement is provided to the first party and the second party subsequent to the commencement of a project.

27. The method of claim 16 wherein the first party includes a project owner.

28. The method of claim 16 wherein the second party includes a general contractor.

29. The method of claim 16 wherein the second party includes a subcontractor of the general contractor.

30. The method of claim 16 wherein the second party includes a sub-subcontractor of a subcontractor.

31. The method of claim 16 wherein the first party comprises one of a project owner, a general contractor, a subcontractor, a sub-subcontractor, a service provider or a maternal supplier

32. The method of claim 16 wherein the second party comprises one of a project owner, a general contractor, a subcontractor, a sub-subcontractor, a service provider or a material supplier

33. The method of claim 16 further comprising the step of scheduling the DRB to meet at predetermined intervals during a predetermined period corresponding to a project.

34. The method of claim 16 further comprising the step of scheduling the DRB to meet at a time selected by one of the first party or the second party.

35. A method of resolving construction related disputes between a first party and a second party, the method comprising:
forming a dispute review board (DRB) including a neutral member, first party neutral, and a second party neutral;
submitting a dispute related to the project to the DRB for resolution in the form of an advisory opinion; and
submitting the dispute to an alternative dispute resolution (ADR) panel in response to a request by one of the first party or the second party.

36. The method of claim 35 wherein the DRB further includes a first party representative and a second party representative.

37. The method of claim 35 wherein the ADR panel includes the neutral individual.

38. The method of claim 35 wherein the ADR panel includes the first party neutral and the second party neutral.

39. The method of claim 35 wherein the step of submitting the dispute to an ADR panel includes the step of submitting the dispute to a mediation conducted by the ADR panel.

40. The method of claim 39 wherein the mediation is a binding mediation.

41. The method of claim 35 wherein the step of submitting the dispute to an ADR panel includes the step of submitting the dispute to an arbitration conducted by the ADR panel.

42. The method of claim 35 wherein the DRB is formed by the first party and the second party prior to commencement of a project.

43. The method of claim 35 wherein the DRB is formed by the first party and the second party upon the commencement of a project.

44. The method of claim 35 wherein the DRB is formed by the first party and the second party subsequent to the commencement of a project.

45. The method of claim 35 wherein the first party includes a project owner.

46. The method of claim 35 wherein the second party includes a general contractor.

47. The method of claim 35 wherein the second party includes a subcontractor of the general contractor.

48. The method of claim 35 wherein the second party includes a sub-subcontractor of a subcontractor.

49. The method of claim 35 wherein the first party comprises one of a project owner, a general contractor, a subcontractor, a sub-subcontractor, a service provider, or a material supplier

50. The method of claim 35 wherein the second party comprises one of a project owner, a general contractor, a subcontractor, a sub-subcontractor, a service provider or a material supplier

51. The method of claim 35 further comprising the step of scheduling the DRB to meet at predetermined intervals during a predetermined period corresponding to a project.

52. The method of claim 35 further comprising the step of scheduling the DRB to meet at a time selected by one of the first party or the second party.
